(19) United States
(12) Patent Application Publication
(10) Pub. No.: US 2006/0193520 A1
(43) Pub. Date: Aug. 31, 2006

(54) Object detection apparatus, learning apparatus, object detection system, object detection method and object detection program

(76) Inventors: Takeshi Mita, Yokohama-shi (JP); Toshimitsu Kaneko, Kawasaki-shi (JP); Osamu Hori, Yokohama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/236,619

(22) Filed: Sep. 28, 2005

(30) Foreign Application Priority Data
Feb. 28, 2005 (JP) 2005-054780

(51) Int. Cl. G06K 9/46; G06K 9/62

(52) U.S. Cl. 382/190; 382/159

(57) ABSTRACT

Object detection apparatus includes storing unit storing learned information learned previously with respect to sample image extracted from an input image and including first information and second information, first information indicating at least one combination of given number of feature-region/feature-value groups selected from plurality of feature-region/feature-value groups each including one of feature areas and one of quantized learned-feature quantities, feature areas each having plurality of pixel areas, and quantized learned-feature quantities obtained by quantizing learned-feature quantities corresponding to feature quantities of feature areas in sample image, and second information indicating whether sample image is an object or non-object, feature-value computation unit computing an input feature value of each of feature areas belonging to combination in input image, quantization unit quantizing computed input feature value to obtain quantized input feature value, and determination unit determining whether input image includes object, using quantized input feature value and learned information.

### CROSS-REFERENCE TO RELATED APPLICATIONS

This application is based upon and claims the benefit of priority from prior Japanese Patent Application No. 2005-054780, filed Feb. 28, 2005, the entire contents of which are incorporated herein by reference.

### BACKGROUND OF THE INVENTION

1. Field of the Invention

The present invention relates to an object detection apparatus, learning apparatus, object detection system, object detection method and object detection program.

2. Description of the Related Art

There is a method of using the brightness difference value between two pixel areas as a feature value for detecting a particular object in an image (see, for example, Paul Viola and Michael Jones, “Rapid Object Detection using a Boosted Cascade of Simple Features”, IEEE conf. on Computer Vision and Pattern Recognition (CVPR), 2001). The feature value can be calculated efficiently if the pixel area is rectangular, and is therefore widely utilized. The method uses a classifier for determining whether the object is present or absent in a scanning sub-window. This classifier determines it by comparing, with a threshold value, a brightness difference value computed from rectangular areas. The accuracy of recognition acquired by the comparison process using the threshold value is not high. However, a high recognition accuracy can be acquired as a whole by combining a number of such classifiers.

Conventional classifiers perform determination based on a single brightness difference value computed from rectangular areas. Using such a single feature value, the correlation between features contained in an object, for example, symmetry of features of the object, cannot effectively be estimated, resulting in a low recognition accuracy. It is apparent that combination of such low-accuracy classifiers will not greatly enhance the recognition accuracy.

### BRIEF SUMMARY OF THE INVENTION

In accordance with a first aspect of the invention, there is provided an object detection apparatus comprising: a storing unit configured to store learned information learned previously with respect to a sample image extracted from an input image and including first information and second information, the first information indicating at least one combination of a given number of feature-region/feature-value groups selected from a plurality of feature-region/feature-value groups each including one of feature areas and one of quantized learned-feature quantities, the feature areas each having a plurality of pixel areas, and the quantized learned-feature quantities obtained by quantizing learned-feature quantities corresponding to feature quantities of the feature areas in the sample image, and the second information indicating whether the sample image is an object or a non-object; a feature-value computation unit configured to compute an input feature value of each of the feature areas belonging to the combination in the input image; a quantization unit configured to quantize the computed input feature value to obtain quantized input feature value; and a determination unit configured to determine whether the input image includes the object, using the quantized input feature value and the learned information.

In accordance with a second aspect of the invention, there is provided a learning apparatus comprising: a first storing unit configured to store at least two sample images, one of the sample images being an object as a detection target and the other sample image being a non-object as a non-detection target; a feature generation unit configured to generate a plurality of feature areas each of which includes a plurality of pixel areas, the feature areas being not more than a maximum number of feature areas which are arranged in each of the sample images; a feature computation unit configured to compute, for each of the sample images, a feature value of each of the feature areas; a probability computation unit configured to compute a probability of occurrence of the feature value corresponding to each of the feature areas, depending upon whether each of the sample images is the object, and then to quantize the feature value into one of a plurality of discrete values based on the computed probability; a combination generation unit configured to generate a plurality of combinations of the feature areas; a joint probability computation unit configured to compute, in accordance with each of the combinations, a joint probability with which the quantized feature quantities are simultaneously observed in each of the sample images, and generate tables storing the generated combinations, the computed joint probabilities, and information indicating whether each of the sample images is the object or the non-object; a determination unit configured to determine, concerning each of the combinations with reference to the tables, whether a ratio of a joint probability indicating the object sample image to a joint probability indicating the non-object sample image is higher than a threshold value, to determine whether each of the sample images is the object; a selector configured to select, from the combinations, a combination which minimizes number of errors in determination results corresponding to the sample images; and a second storing unit which stores the selected combination and one of the tables corresponding to the selected combination.

In accordance with a third aspect of the invention, there is provided a learning apparatus comprising: a first storing unit which stores at least two sample images, one of the sample images being an object as a detection target and the other sample image being a non-object as a non-detection target; an imparting unit configured to impart an initial weight to the stored sample images; a feature generation unit configured to generate a plurality of feature areas each of which includes a plurality of pixel areas, the feature areas being not more than a maximum number of feature areas which are arranged in each of the sample images; a feature computation unit configured to compute, for each of the sample images, a weighted sum of differently weighted pixel areas included in each of the feature areas, or an absolute value of the weighted sum, the weighted sum or the absolute value being used as a feature value corresponding to each of the feature areas; a probability computation unit configured to compute a probability of occurrence of the feature value corresponding to each of the feature areas, depending upon whether each of the sample images is the object, and then to quantize the feature value into one of a plurality of discrete values based on the computed probability; a combination generation unit configured to generate a plurality of combinations of the feature areas; a joint probability computation unit configured to compute, in accordance with each of the combinations, a joint probability with which the quantized feature quantities are simultaneously observed in each of the sample images, and generate tables storing the generated combinations, the quantized feature quantities, a plurality of values acquired by multiplying the computed joint probabilities by the initial weight, and information indicating whether each of the sample images is the object or the non-object; a determination unit configured to determine, concerning each of the combinations with reference to the tables, whether a ratio of a value acquired by multiplying a joint probability indicating the object sample image by the initial weight to a value acquired by multiplying a joint probability indicating the non-object sample image by the initial weight is higher than a threshold value, to determine whether each of the sample images is the object; a selector configured to select, from the combinations, a combination which minimizes number of errors in determination results corresponding to the sample images; a second storing unit which stores the selected combination and one of the tables corresponding to the selected combination; and an update unit configured to update a weight of any one of the sample images to increase the weight when the sample images are subjected to a determination based on the selected combination, and a determination result concerning the any one of the sample images indicating an error,

wherein: the joint probability computation unit generates tables storing the generated combinations, a plurality of values acquired by multiplying the computed joint probabilities by the updated weight, and information indicating whether each of the sample images is the object or the non-object; the determination unit performs a determination based on the values acquired by multiplying the computed joint probabilities by the updated weight; the selector selects, from a plurality of combinations determined based on the updated weight, a combination which minimizes number of errors in determination results corresponding to the sample images; and the second storing unit newly stores the combination selected by the selector, and one of the tables corresponding to the combination selected by the selector.

In accordance with a fourth aspect of the invention, there is provided an object detection system comprising a learning apparatus and an object detection apparatus,

the learning apparatus including: a first storing unit configured to store at least two sample images, one of the sample images being an object as a detection target and the other sample image being a non-object as a non-detection target; a feature generation unit configured to generate a plurality of feature areas each of which includes a plurality of pixel areas, the feature areas being not more than a maximum number of feature areas which are arranged in each of the sample images; a feature computation unit configured to compute, for each of the sample images, a feature value of each of the feature areas; a probability computation unit configured to compute a probability of occurrence of the feature value corresponding to each of the feature areas, depending upon whether each of the sample images is the object, and then to quantize the feature value into one of a plurality of discrete values based on the computed probability; a combination generation unit configured to generate a plurality of combinations of the feature areas; a joint probability computation unit configured to compute, in accordance with each of the combinations, a joint probability with which the quantized feature quantities are simultaneously observed in each of the sample images, and generate tables storing the generated combinations, the computed joint probabilities, and information indicating whether each of the sample images is the object or the non-object; a first determination unit configured to determine, concerning each of the combinations with reference to the tables, whether a ratio of a joint probability indicating the object sample image to a joint probability indicating the non-object sample image is higher than a threshold value, to determine whether each of the sample images is the object; a selector configured to select, from the combinations, a combination which minimizes number of errors in determination results corresponding to the sample images; and a second storing unit which stores the selected combination and one of the tables corresponding to the selected combination, and

the object detection apparatus including: a feature-value computation unit configured to compute an input feature value of each of the feature areas belonging to the combination in an input image; a quantization unit configured to quantize the computed input feature value to obtain quantized input feature value; and a second determination unit configured to determine whether the input image includes the object, using the quantized input feature value and the one of the tables stored in the second storing unit.

In accordance with a fifth aspect of the invention, there is provided an object detection system comprising a learning apparatus and an object detection apparatus,

the learning apparatus including: a first storing unit which stores at least two sample images, one of the sample images being an object as a detection target and the other sample image being a non-object as a non-detection target; an imparting unit configured to impart an initial weight to the stored sample images; a feature generation unit configured to generate a plurality of feature areas each of which includes a plurality of pixel areas, the feature areas being not more than a maximum number of feature areas which are arranged in each of the sample images; a first computation unit configured to compute, for each of the sample images, a weighted sum of differently weighted pixel areas included in each of the feature areas, or an absolute value of the weighted sum, the weighted sum or the absolute value being used as a feature value corresponding to each of the feature areas; a probability computation unit configured to compute a probability of occurrence of the feature value corresponding to each of the feature areas, depending upon whether each of the sample images is the object, and then to quantize the feature value into one of a plurality of discrete values based on the computed probability; a combination generation unit configured to generate a plurality of combinations of the feature areas; a joint probability computation unit configured to compute, in accordance with each of the combinations, a joint probability with which the quantized feature quantities are simultaneously observed in each of the sample images, and generate tables storing the generated combinations, the quantized feature quantities, a plurality of values acquired by multiplying the computed joint probabilities by the initial weight, and information indicating whether each of the sample images is the object or the non-object; a first determination unit configured to determine, concerning each of the combinations with reference to the tables, whether a ratio of a value acquired by multiplying a joint probability indicating the object sample image by the initial weight to a value acquired by multiplying a joint probability indicating the non-object sample image by the initial weight is higher than a threshold value, to determine whether each of the sample images is the object; a selector configured to select, from the combinations, a combination which minimizes number of errors in determination results corresponding to the sample images; a second storing unit which stores the selected combination and one of the tables corresponding to the selected combination; and an update unit configured to update a weight of any one of the sample images to increase the weight when the sample images are subjected to a determination based on the selected combination, and a determination result concerning the any one of the sample images indicates an error,

wherein: the joint probability computation unit generates tables storing the generated combinations, a plurality of values acquired by multiplying the computed joint probabilities by the updated weight, and information indicating whether each of the sample images is the object or the non-object; the first determination unit performs a determination based on the values acquired by multiplying the computed joint probabilities by the updated weight; the selector selects, from a plurality of combinations determined based on the updated weight, a combination which minimizes number of errors in determination results corresponding to the sample images; and the second storing unit newly stores the combination selected by the selector, and one of the tables corresponding to the combination selected by the selector,

the object detection apparatus including: a second computation unit configured to compute an input feature value of each of the feature areas belonging to the combination in an input image; a quantization unit configured to quantize the computed input feature value into one of the discrete values in accordance with the input feature value to obtain quantized input feature value; a second determination unit configured to determine whether the input image includes the object, referring to the selected combination and the one of the tables; and a total determination unit configured to determine whether the input image includes the object, using a weighted sum acquired by imparting weights to a plurality of determination results acquired by the second determination unit concerning the plurality of combinations.

In accordance with a sixth aspect of the invention, there is provided an object detection method comprising: storing learned information learned previously with respect to a sample image extracted from an input image and including first information and second information, the first information indicating at least one combination of a given number of feature-region/feature-value groups selected from a plurality of feature-region/feature-value groups each including one of feature areas and one of quantized learned-feature quantities, the feature areas each having a plurality of pixel areas, and the quantized learned-feature quantities obtained by quantizing learned-feature quantities corresponding to feature quantities of the feature areas in the sample image, and the second information indicating whether the sample images is an object or a non-object; computing an input feature value of each of the feature areas belonging to the combination in the input image; quantizing the computed input feature value to obtain quantized input feature value; and determining whether the input image includes the object, using the quantized input feature value and the learned information.

In accordance with a seventh aspect of the invention, there is provided a learning method comprising: storing at least two sample images, one of the sample images being an object as a detection target and the other sample image being a non-object as a non-detection target; generating a plurality of feature areas each of which includes a plurality of pixel areas, the feature areas being not more than a maximum number of feature areas which are arranged in each of the sample images; computing, for each of the sample images, a feature value of each of the feature areas; computing a probability of occurrence of the feature value corresponding to each of the feature areas, depending upon whether each of the sample images is the object, and then quantizing the feature value into one of a plurality of discrete values based on the computed probability; generating a plurality of combinations of the feature areas; computing, in accordance with each of the combinations, a joint probability with which the quantized feature quantities are simultaneously observed in each of the sample images, and generating tables storing the generated combinations, the computed joint probabilities, and information indicating whether each of the sample images is the object or the non-object; determining, concerning each of the combinations with reference to the tables, whether a ratio of a joint probability indicating the object sample image to a joint probability indicating the non-object sample image is higher than a threshold value, to determine whether each of the sample images is the object; selecting, from the combinations, a combination which minimizes number of errors in determination results corresponding to the sample images; and storing the selected combination and one of the tables corresponding to the selected combination.

In accordance with an eighth aspect of the invention, there is provided a learning method comprising: storing at least two sample images, one of the sample images being an object as a detection target and the other sample image being a non-object as a non-detection target; imparting an initial weight to the stored sample images; generating a plurality of feature areas, each of which includes a plurality of pixel areas, the feature areas being not more than a maximum number of feature areas which are arranged in each of the sample images; computing, for each of the sample images, a weighted sum of differently weighted pixel areas included in each of the feature areas, or an absolute value of the weighted sum, the weighted sum or the absolute value being used as a feature value corresponding to each of the feature areas; computing a probability of occurrence of the feature value corresponding to each of the feature areas, depending upon whether each of the sample images is the object, and then quantizing the feature value into one of a plurality of discrete values based on the computed probability; generating a plurality of combinations of the feature areas; computing, in accordance with each of the combinations, a joint probability with which the quantized feature quantities are simultaneously observed in each of the sample images, and generating tables storing the generated combinations, the quantized feature quantities, a plurality of values acquired by multiplying the computed joint probabilities by the initial weight, and information indicating whether each of the sample images is the object or the non-object; determining, concerning each of the combinations with reference to the tables, whether a ratio of a value acquired by multiplying a joint probability indicating the object sample image by the initial weight to a value acquired by multiplying a joint probability indicating the non-object sample image by the initial weight is higher than a threshold value, to determine whether each of the sample images is the object; selecting, from the combinations, a combination which minimizes number of errors in determination results corresponding to the sample images; storing the selected combination and one of the tables corresponding to the selected combination; updating a weight of any one of the sample images to increase the weight when the sample images are subjected to a determination based on the selected combination, and a determination result concerning the any one of the sample images indicating an error; generating tables storing the generated combinations, a plurality of values acquired by multiplying the computed joint probabilities by the updated weight, and information indicating whether each of the sample images is the object or the non-object; performing a determination based on the values acquired by multiplying the computed joint probabilities by the updated weight; selecting, from a plurality of combinations determined based on the updated weight, a combination which minimizes number of errors in determination results corresponding to the sample images; and newly storing the selected combination and one of the tables corresponding to the selected combination.

In accordance with a ninth aspect of the invention, there is provided an object detection program stored in a computer-readable medium using a computer, the program comprising: means for instructing the computer to store learned information learned previously with respect to a sample image extracted from an input image and including first information and second information, the first information indicating at least one combination of a given number of feature-region/feature-value groups selected from a plurality of feature-region/feature-value groups each including one of feature areas and one of quantized learned-feature quantities, the feature areas each having a plurality of pixel areas, and the quantized learned-feature quantities obtained by quantizing learned-feature quantities corresponding to feature quantities of the feature areas in the sample image, and the second information indicating whether the sample images is an object or a non-object; computation means for instructing the computer to compute an input feature value of each of the feature areas belonging to the combination in the input image; means for instructing the computer to quantize the computed input feature value to obtain quantized input feature value; and determination means for instructing the computer to determine whether the input image includes the object, using the quantized input feature value and the learned information stored.

In accordance with a tenth aspect of the invention, there is provided a learning program stored in a computer-readable medium, the program comprising: means for instructing a computer to store at least two sample images, one of the sample images being an object as a detection target and the other sample image being a non-object as a non-detection target; means for instructing the computer to generate a plurality of feature areas each of which includes a plurality of pixel areas, the feature areas being not more than a maximum number of feature areas which are arranged in each of the sample images; means for instructing the computer to compute, for each of the sample images, a feature value of each of the feature areas; means for instructing the computer to compute a probability of occurrence of the feature value corresponding to each of the feature areas, depending upon whether each of the sample images is the object, and then to quantize the feature value into one of a plurality of discrete values based on the computed probability; means for instructing the computer to generate a plurality of combinations of the feature areas; means for instructing the computer to compute, in accordance with each of the combinations, a joint probability with which the quantized feature quantities are simultaneously observed in each of the sample images, and generate tables storing the generated combinations, the computed joint probabilities, and information indicating whether each of the sample images is the object or the non-object; means for instructing the computer to determine, concerning each of the combinations with reference to the tables, whether a ratio of a joint probability indicating the object sample image to a joint probability indicating the non-object sample image is higher than a threshold value, to determine whether each of the sample images is the object; means for instructing the computer to select, from the combinations, a combination which minimizes number of errors in determination results corresponding to the sample images; and means for instructing the computer to store the selected combination and one of the tables corresponding to the selected combination.

In accordance with an eleventh aspect of the invention, there is provided a learning program stored in a computer-readable medium, the program comprising: means for instructing a computer to store at least two sample images, one of the sample images being an object as a detection target and the other sample image being a non-object as a non-detection target; means for instructing the computer to impart an initial weight to the stored sample images; means for instructing the computer to generate a plurality of feature areas each of which includes a plurality of pixel areas, the feature areas being not more than a maximum number of feature areas which are arranged in each of the sample images; means for instructing the computer to compute, for each of the sample images, a weighted sum of differently weighted pixel areas included in each of the feature areas, or an absolute value of the weighted sum, the weighted sum or the absolute value being used as a feature value corresponding to each of the feature areas; means for instructing the computer to compute a probability of occurrence of the feature value corresponding to each of the feature areas, depending upon whether each of the sample images is the object, and then to quantize the feature value into one of a plurality of discrete values based on the computed probability; means for instructing the computer to generate a plurality of combinations of the feature areas; acquisition means for instructing the computer to compute, in accordance with each of the combinations, a joint probability with which the quantized feature quantities are simultaneously observed in each of the sample images, and generate tables storing the generated combinations, the quantized feature quantities, a plurality of values acquired by multiplying the computed joint probabilities by the initial weight, and information indicating whether each of the sample images is the object or the non-object; determination means for instructing the computer to determine, concerning each of the combinations with reference to the tables, whether a ratio of a value obtained by multiplying a joint probability indicating the object sample image by the initial weight to a value obtained by multiplying a joint probability indicating the non-object sample image by the initial weight is higher than a threshold value, to determine whether each of the sample images is the object; selection means for instructing the computer to select, from the combinations, a combination which minimizes number of errors in determination results corresponding to the sample images; storing means for instructing the computer to store the selected combination and one of the tables corresponding to the selected combination; and means for instructing the computer to update a weight of any one of the sample images to increase the weight when the sample images are subjected to a determination based on the selected combination, and a determination result concerning the any one of the sample images indicating an error,

wherein: the acquisition means instructs the computer to generate tables storing the generated combinations, a plurality of values obtained by multiplying the computed joint probabilities by the updated weight, and information indicating whether each of the sample images is the object or the non-object; the determination means instructs the computer to perform a determination based on the values obtained by multiplying the computed joint probabilities by the updated weight; the selection means instructs the computer to select, from a plurality of combinations determined based on the updated weight, a combination which minimizes number of errors in determination results corresponding to the sample images; and the storing means instructs the computer to newly store the selected combination, and one of the tables corresponding to the selected combination.

### BRIEF DESCRIPTION OF THE SEVERAL VIEWS OF THE DRAWING

FIG. 1 is a block diagram illustrating an object detection apparatus according to an embodiment of the invention;

FIG. 2 is a block diagram illustrating the classifier appearing in FIG. 1;

FIG. 3 is a view showing a group example of pixel areas used by the feature value computation unit appearing in FIG. 2 to compute a weighted sum;

FIG. 4 is a view illustrating a group example of rectangular pixel areas;

FIG. 5 is a view illustrating a plurality of features (a group of pixel areas) arranged on a certain face-image sample as a detection target;

FIG. 6 is a block diagram illustrating a case where the classifier of FIG. 1 comprises a plurality of classifier components;

FIG. 7 is a view illustrating a state in which an input image is scanned by the scan unit appearing in FIG. 1, using scan windows of different sizes;

FIG. 8 is a view illustrating a state in which input images of different sizes are scanned by the scan unit appearing in FIG. 1;

FIG. 9 is a block diagram illustrating a learning apparatus for computing parameters used by the classifier of FIG. 2;

FIG. 10 is a flowchart useful in explaining the operation of the learning apparatus;

FIG. 11 is a view illustrating an example of a feature generated by the feature generation unit appearing in FIG. 9;

FIGS. 12A, 12B and 12C are graphs illustrating probability density distributions computed by the feature value computation unit appearing in FIG. 9;

FIG. 13 is a block diagram illustrating a learning apparatus for computing parameters used by the classifiers appearing in FIG. 6; and

FIG. 14 is a flowchart useful in explaining the operation of the learning apparatus of FIG. 13.

### DETAILED DESCRIPTION OF THE INVENTION

Referring to the accompanying drawings, a detailed description will be given of an object detection apparatus, learning apparatus, object detection system, object detection method and object detection program according to an embodiment of the invention.

The embodiment has been developed in light of the above, and aims to provide an object detection apparatus, learning apparatus, object detection system, object detection method and object detection program, which can detect and enable detection of an object with a higher accuracy than in the prior art.

The object detection apparatus, learning apparatus, object detection system, object detection method and object detection program of the embodiment can detect an object and enable detection of an object with a higher accuracy than in the prior art.

(Object Detection Apparatus)

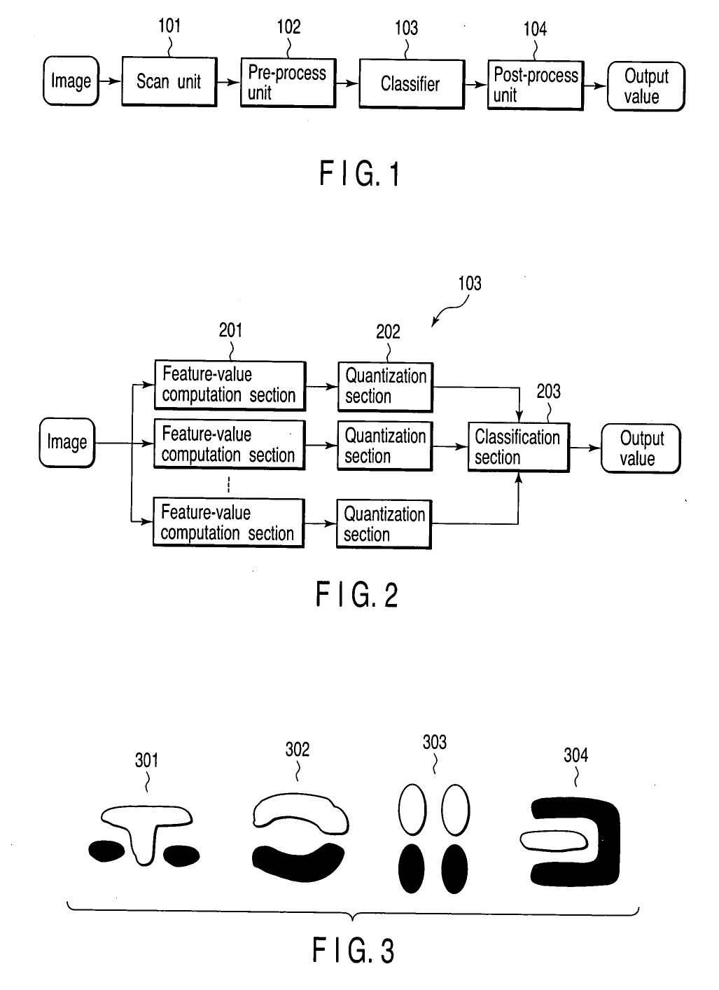

Referring first to FIG. 1, the object detection apparatus of the embodiment will be described.

As shown, the object detection apparatus comprises a scan unit 101, pre-process unit 102, classifier 103 and post-process unit 104.

The scan unit 101 receives an image and scans it with a window (scan window) of a predetermined size. The scan unit 101 moves the scan window with a predetermined step width from the point of origin on the input image.

The pre-process unit 102 performs a pre-process, such as smoothing or brightness correction, on an image acquired by the scan unit 101 in units of windows, and removes, from the image, noise, the influence of variation in illumination, etc. Concerning the pre-process, two cases can be considered. Namely, the pre-process is performed on a portion of the image contained in each scan window, or on the entire image. In the latter case, the order of the scan unit 101 and pre-process unit 102 is changed to enable the pre-process to be performed before scanning.

Specifically, the pre-process unit 102 performs a pre-process for acquiring, for example, the logarithm of the brightness value of the image. If the difference value of the logarithm of a brightness value instead of the brightness value itself is regarded as a feature value, the feature value can be reliably acquired even from, for example, an image of an object photographed in a dark place using a dynamic range, which differs from a sample used for learning. The pre-process unit 102 may perform, as well as the above, histogram smoothing in each scan window, or a process for adjusting brightness values to a certain mean and variance. These processes are effective as pre-processes for absorbing variations in photography conditions or photography system. Further, note that if the input image is processed by another means and can be directly input to the classifier 103, the scan unit 101 and pre-process unit 102 are not necessary.

The classifier 103 performs a process for determining whether a partial image in a scan window is an object. Upon detecting an object, the classifier 103 stores data indicating the position of the object. The classifier 103 will be described later in detail with reference to FIGS. 2 to 6.

After that, the object detection apparatus repeats the scan and determination processes until the last portion of the image is processed. In general, a plurality of detection positions can be acquired for a single object, although the number of detection positions depends upon the step width of scanning.

When a plurality of detection positions are acquired for a single object, the post-process unit 104 incorporates the detection positions into one to determine a single detection position for the single object, and outputs the resultant position. Where a plurality of detection positions are acquired for a single object, these positions are close to each other, and hence can be incorporated into one. The post-process unit 104 performs the post-process using the method described in, for example, H. A. Rowley, S. Baluja and T. Kanade, “Neural network-based face detection”, IEEE Trans. on PAMI, Vol. 20, No. 1, pp. 23-38 (1998).

(Classifier 103)

Referring to FIG. 2, the classifier 103 will be described in detail.

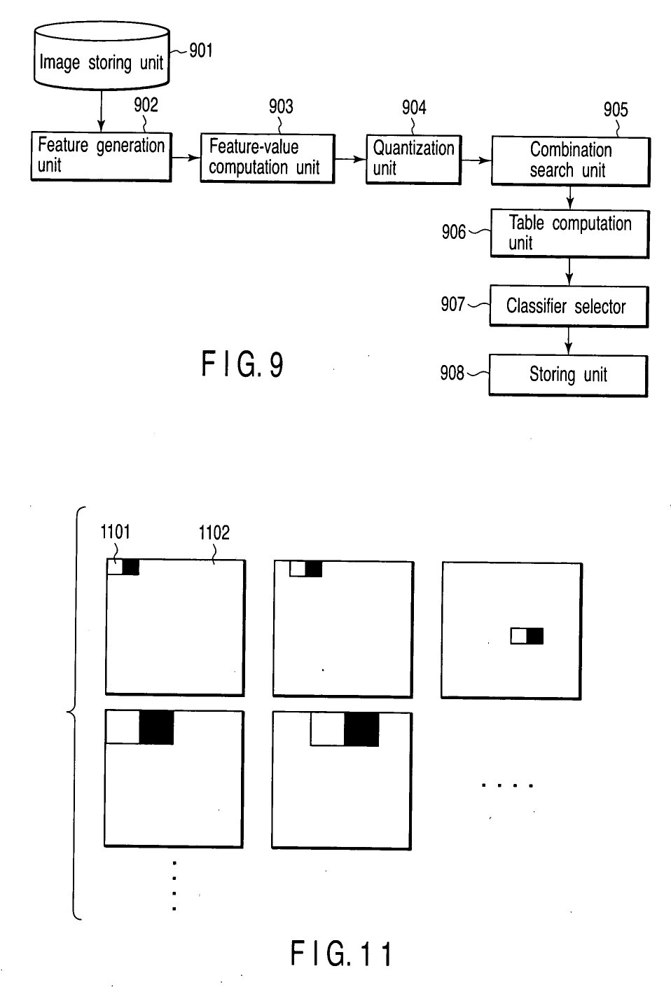

The classifier 103 comprises a plurality of feature value computation sections 201, a plurality of quantization sections 202 and a classification section 203. Assume here that parameters, such as a group of pixel areas or threshold values used during detection by the object detection apparatus of the embodiment, are beforehand acquired by a learning apparatus that will be described later with reference to FIGS. 9 to 13.

Each feature value computation section 201 computes the weighted sum of pixel values for a combination of corresponding pixel areas.

Each quantization section 202 quantizes, into one of a plurality of discrete values, the weighted sum supplied from the corresponding feature value computation section 201 connected thereto.

The classification section 203 receives the output values of the quantization sections 202, determines from the combination of the output values whether the input image is a detection target, and outputs a determination result. The classification section 203 outputs two discrete values as output values. Specifically, when the input image is a detection target, a value of, for example, +1 is output, whereas when it is not a detection target, a value of, for example, −1 is output. Alternatively, the classification section 203 may output continuous values. For instance, the higher the possibility of the input image being regarded as a detection target, the closer to +1 (e.g., 0.8 or 0.9) the output, whereas the lower the probability, the closer to −1 the output.

<Feature Value Computation Sections 201>

Referring to FIG. 3, the feature value computation sections 201 will be described. FIG. 3 shows examples of combinations of pixel areas used by the feature value computation sections 201 to compute the sum of weighted values. For instance, a pixel-area combination 301 includes three pixel areas, and a pixel-area combination 302 includes two pixel areas. Assume that the position and configuration of each pixel area, the number of pixel areas, etc., are preset by a learning apparatus described later. As will be described later, the learning apparatus acquires, from combinations of feature areas each having a plurality of pixel areas, the one from which an object can be detected most easily.

Each feature value computation section 201 computes the sum of the pixel values of each pixel area, and then computes a weighted sum D by multiplying each sum by a weight preset for each pixel area, and summing up the multiplication results. The weighted sum D is given by

$$D = {\sum }_{i = 1}^{n} {w}_{i} \cdot {I}_{i}$$

where n is the number of pixel areas, wᵢ is a weight set for each pixel area, and Iᵢ is the sum of the pixel values of each pixel area. For instance, assuming that pixel areas are formed of white and black areas as shown in FIG. 3, the weighted sum D is give by
D=w_{W}·I_{W}+w_{B}·I_{B}
where w_{W} and w_{B} are weights imparted to white and black pixel areas, respectively, I_{W} and I_{B} are the sums of the pixel values of the white and black pixel areas, respectively. In particular, assuming that the numbers of the pixels of the white and black pixel areas are represented by A_{W} and A_{B}, respectively, the weights are defined by

$${w}_{W} = \frac{1}{{A}_{W}} , {w}_{B} = - \frac{1}{{A}_{B}}$$

At this time, the weighted sum D is the difference value of the average brightness of each pixel area. The weighted sum D varies depending upon the arrangement, size and/or configuration of each pixel area, and serves as a feature value that represents the feature of each pixel area. Hereinafter, the weighted sum D will be referred to as a “feature value”, and each combination of pixel areas will be referred to simply as a “feature” (or “feature area”). Further, in the description below, a case will be given where the difference value of the average brightness of each pixel area is used as a “feature value”. Note that the absolute value of the average brightness of each pixel area or the difference value of the logarithm of the average brightness of each pixel area may be used as a “feature value” instead of the difference value of the average brightness of each pixel area. Further, note that each pixel area can be formed of a single pixel at minimum, but in this case, each pixel area is easily influenced by noise. To avoid this, it is desirable to acquire the average brightness of a greater number of pixels.

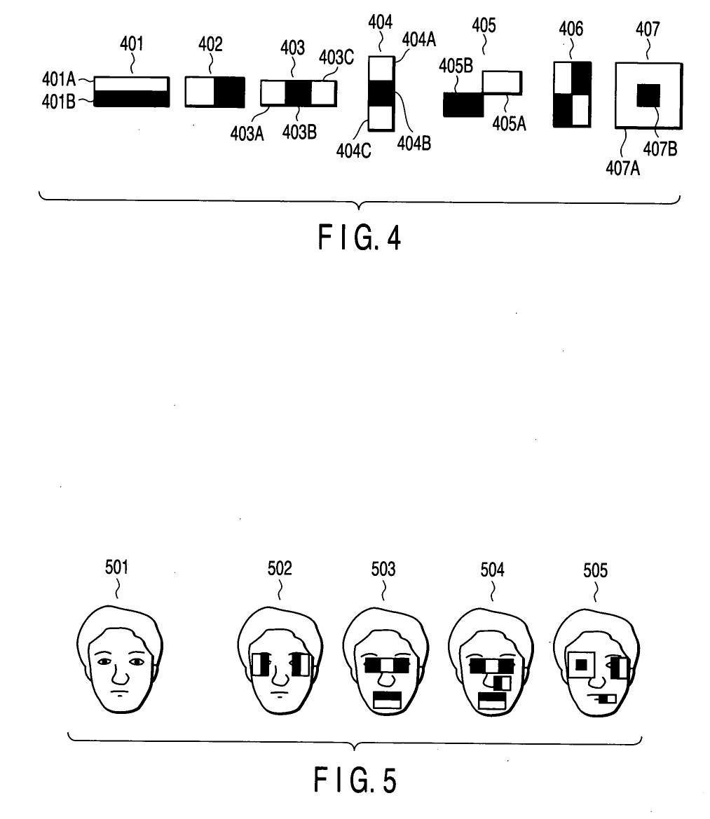

Referring to FIG. 4, a description will be given of the operation of each feature value computation section 201 for a more practical pixel area.

FIG. 4 is a view showing features (i.e., combinations of pixel areas) in which the pixel areas are all rectangular. For instance, a feature 401 includes rectangular pixel areas 401A and 401B adjacent to each other. The features 401 and 402 are combinations of most basic rectangular areas. The feature quantities acquired from the features 401 and 402 represent inclinations in brightness at emphasis positions, i.e., the directions and intensities of edges. The larger the rectangular area, the lower space frequency the edge feature has. Further, if the absolute value of the difference value concerning each rectangular area is used, it can be detected whether an edge exists, although the direction of the brightness inclination cannot be expressed. This serves as an effective feature in an object outline portion at which the brightness level of the background is indefinite. Features 403 and 404 are formed of a combination of three rectangular pixel areas 403A, 403B and 403C and a combination of three rectangular pixel areas 404A, 404B and 404C, respectively. A feature 405 includes two rectangular pixel areas 405A and 405B. In this case, since the pixel areas 405A and 405B are arranged obliquely with respect with each other, the feature 405 provides a brightness inclination in an oblique direction in the input image. A feature 406 is formed of a combination of four rectangular pixel areas. A feature 407 includes a pixel area 407A and a pixel area 407B that surrounds the area 407A, therefore can be used to detect an isolated point.

If the configurations of features are limited to rectangles as described above, the number of computations performed for acquiring the sum of pixel values can be reduced, utilizing “Integral Image” disclosed in the above-mentioned document by Paul Viola and Michael Jones, compared to the case of using pixel areas of arbitrary configurations. Further, if a combination of adjacent pixel areas is used as a feature, the increase/decrease inclination of the brightness of a local area can be estimated. For instance, when an object is detected in an image acquired by photography outside during the day, great variation in brightness may well occur at the surface of the object because of the influence of lighting. However, if attention is paid to only the increase/decrease inclination of the brightness of a local area, it is understood that the local area is relatively free from the influence of an absolute brightness change by lighting. A description will now be given of the case where a combination of adjacent rectangular areas is used as a feature in light of the advantages that this feature requires a small number of computations and is strong against variation in lighting condition.

Specifically, referring to FIG. 5, a description will be given of examples where a plurality of features are arranged on face image samples as detection targets. In this case, it will be proved that the accuracy of classification for classifying an object as a detection target from the other portion (non-object) can be enhanced by combining a plurality of features.

Reference numeral 501 denotes an image of a face as a detection target, which is photographed in front. Since faces photographed in front are substantially symmetrical, if two combinations of rectangular areas are arranged at and around both eyes as shown in a face sample 502, a correlation exists between the two combinations in the direction of a brightness inclination and the degree of brightness. The object detection apparatus of the embodiment utilizes such a correlation between features to enhance the accuracy of classification for classifying a detection target. Even if a detection target cannot be classified by a single feature, it can be classified using a plurality of features unique thereto.

Reference numeral 503 denotes a face sample in which a combination of three areas is arranged to cover both eyes, and a combination of two areas is arranged on the mouth. In general, the portion between the eyebrows is brighter than the eyes, and the mouth is darker than its periphery. Using the two combinations of rectangular areas, it can be estimated whether such face features are simultaneously included. Reference numerals 504 and 505 denote face samples in which three combinations of rectangular areas are arranged. If the number of combinations of rectangular areas and/or the types of combinations of rectangular areas is appropriately selected, combinations of features included only in a detection target can be detected, which enhances the accuracy of classification for classifying the detection object from the non-objects (e.g., background).

<Quantization Section 202>

Each quantization section 202 quantizes the feature value computed by a learning apparatus using preset features. For instance, the difference value (feature value) of the average brightness of rectangular areas acquired by equations 3 is a continuous value. Each quantization section 202 quantizes it into one of a plurality of discrete values. The threshold value or threshold values, based on which the discrete values for quantization are set, are predetermined by learning. For instance, when two discrete values are used as quantization values, the output of each quantization section 202 is, for example, 0 or 1.

<Classification Section 203>

The classification section 203 receives the feature quantities acquired by quantization by the quantization sections 202, and determines from their combination whether the input image is a detection object. Specifically, firstly, the probability (joint probability) of simultaneously observing values output from all quantization sections 202 is determined referring to probability tables acquired by learning. These tables are prepared by the learning apparatus for respective classes of objects (detection targets) and non-objects. The classification section 203 refers to two probability values. Subsequently, the classification section 203 compares the two values for the determination (classification), using the following expression. The probability is called likelihood.

$${h}_{t} ( x ) = \{ \begin{matrix}\frac{P ( {v}_{ 1} , … , {v}_{ F} \vert object )}{P ( {v}_{ 1} , … , {v}_{ F} \vert non \text{-} object )} > λ \\ otherwise\end{matrix} \begin{matrix}⇒ object \\ ⇒ non \text{-} object\end{matrix}$$

where hₜ(x) is a classifying function for acquiring a classification result concerning an image x. Further, P(v₁, . . . , v_{F}|object) and P(v₁, . . . , v_{F}|non-object) are the likelihood of an object and that of a non-object acquired referring to the probability tables, respectively. v_{f} (1≦f≦F, f is an integer) is the quantization value of a feature value computed from the output of the f^{th} quantization section 202, i.e., the f^{th} feature. λ is a threshold value preset by the learning apparatus for classification.

The classification section 203 outputs a label of +1, which indicates that the input image is a detection target, or a label of −1, which indicates that the input image is not a detection target. Further, the classification section 203 may output the ratio between probability values, i.e., (likelihood ratio), or the logarithm of the likelihood ratio. The logarithm of the likelihood ratio is a positive value if the input image is a detection target, and is a negative value if the input image is not a detection target.

The size of the probability tables to refer to is determined based on the number of features used, and the number of quantization stages (discrete values) prepared for each feature value. For example, in the classification section 203 using three features, if the feature value acquired from each feature is quantized into one of the two discrete values, the number of combinations of the values output from the quantization sections is 8 (=2×2×2). In general, in the case of F combinations of features in total, assuming that the feature value acquired from the f^{th} feature is quantized into one of L_{f} discrete values, the number of combinations of the values output from the quantization sections is given by

$${L}_{A} = {\prod }_{f = 1}^{F} {L}_{f}$$

In the above, the method of storing probability values in two tables and comparing them has been described. Alternatively, only comparison results may be stored in a single table, and this table be referred to. As the comparison results, class labels, such as +1 and −1, likelihood ratios as mentioned above, or the logarithms of the likelihood ratios may be used. It is more advantageous to store only comparison results in a table than to refer to probability values and perform comparison, since the required computation cost is smaller in the former than in the latter.

As described above, the object detection apparatus of the embodiment performs classification by using a plurality of combinations of pixel areas, and estimating a correlation between the feature quantities acquired from the combinations.

<<A plurality of Classifiers>>

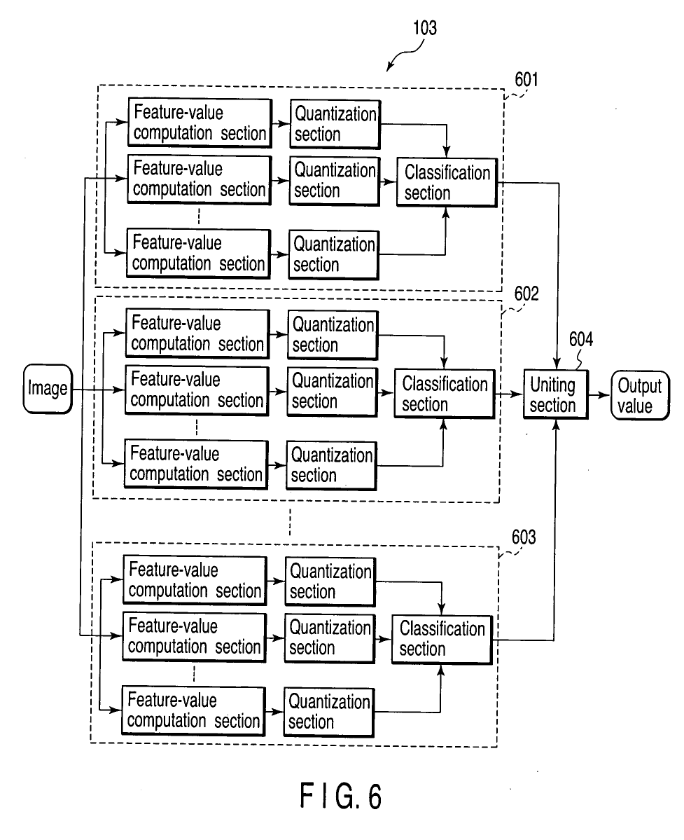

The above-described classifier 103 shown in FIG. 2 determines whether an input image is an object as a detection target. If a plurality of classifiers similar to the classifier 103 are combined, a higher-accuracy classification device can be realized. FIG. 6 shows a configuration example of this classification device. As shown, an input image is input in parallel to classifiers 601 to 603. Although these classifiers perform a classification process in parallel, they use different features. Namely, by combining classifiers that estimate different features, the classification accuracy can be enhanced. For instance, it is possible to use features acquired from an object under different conditions (concerning, e.g., illumination, photography angle, makeup, decoration, etc.), or to the features of different objects.

A uniting section 604 unites the outputs of the classification sections into a final classification result, and outputs it. For uniting, there is a method for acquiring H(x), given by the following equation, as the weighted majority decision of hₜ(x) values as the outputs of T classifiers:

$$H ( x ) = {\sum }_{t = 1}^{T} {α}_{t} \cdot {h}_{i} ( x )$$

where αₜ is a weight imparted to each classifier and preset by the learning apparatus. The uniting section 604 compares H(x) with a preset threshold value to finally determine whether the input image is a detection target. In general, “0” is used as the threshold value. Namely, the uniting section 604 estimates whether H(x) is a positive or negative value.

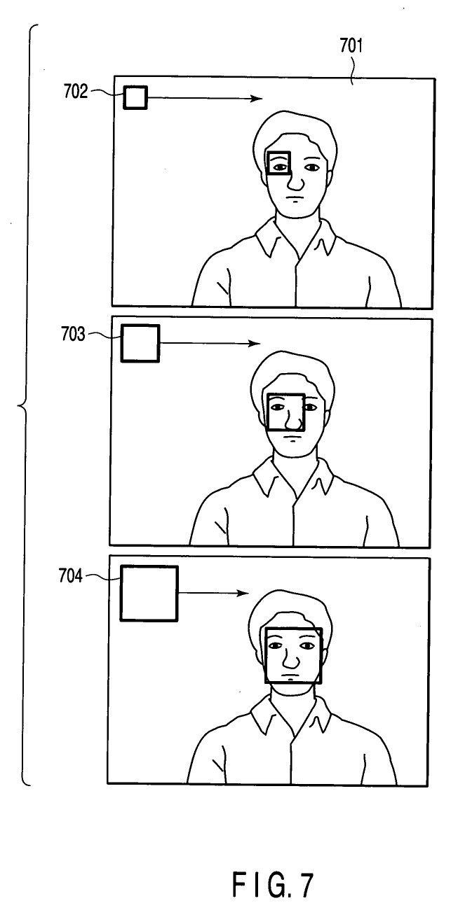

Referring then to FIG. 7, a description will be given of scanning performed by the scan unit 101 using a scan window. FIG. 7 shows an example case where the position of the face of a person is detected in an input image 701.

The scan unit 101 scans the input image with a scan window 702 beginning with the origin of the input image, thereby acquiring a partial image at each position and inputting it to the pre-process unit 102 and classifier 103. The classifier 103 repeats classification processing.

The scan unit 101 repeats the above-described scan, with the size of the scan window varied as indicated by reference numerals 703 and 704. If the face has substantially the same size as the scan window, it is determined that the partial image input at the position of the face corresponds to the face. If the partial image is acquired at any other position or the scan window does not have an appropriate size, it is determined that the partial image does not correspond to the face. The object apparatus may actually employ a method for performing classification by changing the size of rectangular areas used for feature extraction, together with the change of the scan window size, instead of extracting partial images. This method can omit the process of extracting partial images and copying them in a memory area secured to this end, thereby reducing the number of computations.

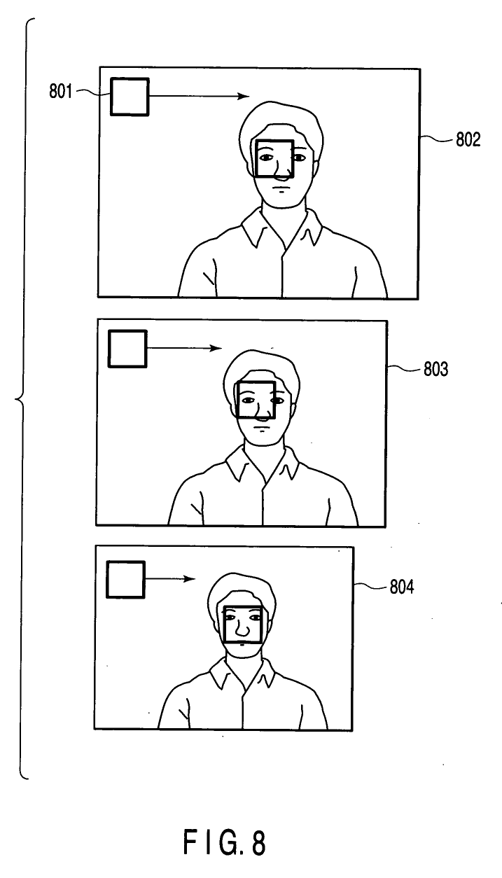

Instead of the method of changing the scan window, a method of changing the size of the input image may be employed. Referring to FIG. 8, the latter method will be described.

In the case of FIG. 8, an input image 802 is sequentially reduced in size, with a scan window 801 unchanged in size. As a result, input images 803 and 804 are generated to detect the face in the image. In this case, when the size of the face in the image becomes substantially the same as that of the scan window while changing the input image, the object detection apparatus can acquire a correct detection result.

(Learning Apparatus)

Referring to FIG. 9, the learning apparatus used in the embodiment will be described. The learning apparatus of FIG. 9 computes parameters used by the classifier 103 of FIG. 2. The learning apparatus statistically computes features (in this case, the position and size of each pixel area) for classifying sample images of two classes, or parameters, such as threshold values, from a large number of object images as detection targets and non-object images to be classified from the object images, which are prepared beforehand. Such features or parameters are used by the object detection apparatus descried above.

The learning apparatus comprises an image storing unit 901, feature generation unit 902, feature value computation unit 903, quantization unit 904, combination search unit 905, table computation unit 906, classifier selector 907 and storing unit 908.

The image storing unit 901 stores a large number of image samples of two classes, i.e., object images as detection targets and non-object images. Assume that the sample images have the same size, and in particular, concerning the image samples as object images, the position and size of an object in each sample image are normalized. A face image, for example, is normalized based on the positions of, for example, eyes, nose, etc. However, it is not always necessary for the image storing unit 901 to store normalized images. Alternatively, normalization means for normalizing the position and/or size of an object may be employed in addition to the image storing unit 901, and the images accumulated by the unit 901 be normalized by this means when learning is started. In this case, information, for example, concerning the position of a point referred to when the position and/or size of an object is normalized is required, therefore the image storing unit 901 is necessary to pre-store such information in relation to each sample image. In the description below, it is assumed that normalized images are accumulated.

In accordance with an image size (e.g., 20×20 pixels) stored in the image storing unit 901, the feature generation unit 902 generates all features (such image-area combinations as shown in FIG. 3 or such rectangular-area combinations as shown in FIG. 4) that can be arranged in each sample image. The feature generation unit 902 generates a number of feature areas each including a plurality of pixel areas, setting, as an upper limit, a maximum number of feature areas that can be arranged in each sample image.

The feature value computation unit 903 acquires a feature value (e.g., the weighted sum of pixel values) corresponding to each feature generated by the feature generation unit 902. As the feature value, the difference value of the average brightness of each pixel area or the absolute value of the difference value can be used. The feature value computation unit 903 determines, for example, a threshold value (or threshold values) for quantization of all sample images after computing feature quantities for all sample images, which correspond to each feature.

Based on the threshold value(s) determined by the feature value computation unit 903, the quantization unit 904 quantizes, into one of discrete values, each of the feature quantities acquired by the feature value computation unit 903. The quantization unit 904 performs the same quantization on the feature quantities corresponding to another feature generated by the feature generation unit 902. After repeating this, the quantization unit 904 acquires quantized values related to the feature quantities and corresponding to a plurality of features.

The combination search unit 905 generates combinations of the features. The quantization unit 904 acquires the probability of occurrence of a feature value in units of feature areas, depending upon whether each sample image is the object, and determines, based on the acquired probability, how many discrete values the computed feature value should be quantized into.

The table computation unit 906 computes the probability with which the quantized feature quantities corresponding to each combination generated by the combination search unit 905 can be simultaneously observed, and then computes two probability tables used for classification, one for the object and the other for the non-object.

After repeating the above-described processes concerning various features of different positions and sizes and on all possible combinations of the features, the classifier selector 907 selects an optimal feature or an optimal combination of features. For facilitating the description, this selection may be paraphrased such that the classifier selector 907 selects an optimal classifier.

The storing unit 908 stores the optimal feature or optimal combination of features, and probability tables acquired therefrom. The object detection apparatus refers to these tables.

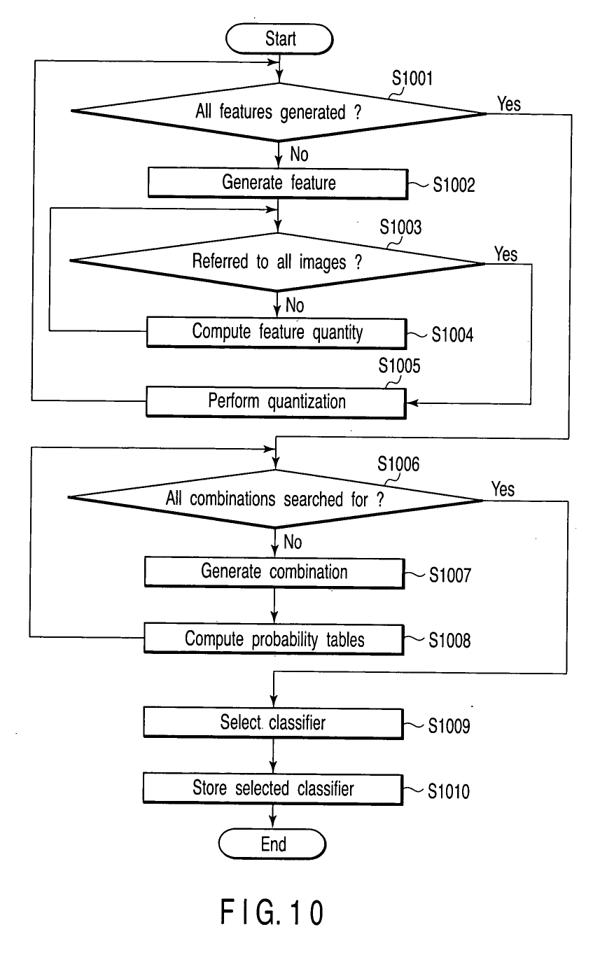

The operation of the learning apparatus of FIG. 9 will be described with reference to FIG. 10. FIG. 10 is a flowchart useful in explaining the learning procedure of the classifier.

The basic process of the learning apparatus is to compute feature quantities from all sample images in units of features that can be arranged in each sample image, and in units of combinations of the features, and to store an optimal feature for determining whether each sample image is a detection target, and probability tables corresponding thereto. The important point, which differs from the conventional method, lies in that information concerning a correlation between the features existing in object is extracted from the combinations of features, and used for classification. Concerning all features that can be arranged in an image, if all possible pixel areas of arbitrary configurations and arrangements are generated to search for all feature quantities, the number of computations becomes enormous and hence this is impractical. In light of this, the number of searches is reduced using, for example, combinations of rectangular areas as shown in FIG. 5. Further, as is mentioned above, if the feature areas are limited to rectangular ones, the number of computations required for feature extraction can be significantly reduced. In addition, the use of combinations of adjacent rectangular areas can further reduce the number of searches, and can estimate a local feature that is not easily influenced by variation in illumination. Moreover, concerning the combinations of all features, the number of such combinations is enormous. To avoid this, information indicating the maximum number of features to be combined is beforehand supplied, and the optimal combination is selected from the possible combinations of the features. Also in this case, if the number of feature to be combined is increased, the number of their combinations is enormous. For instance, the combination of 3 from 10, ₁₀C₃, is 120. Thus, a large number of computations are required. A countermeasure for dealing with such an enormous number of combinations will be described later.

Firstly, the feature generation unit 902 generates a feature, and it is determined whether all features are generated (step S1001). If all features are not yet generated, the program proceeds to step S1002, whereas if all features are already generated, the program proceeds to step S1006. At step S1002, the feature generation unit 902 generates another feature. At this time, if the position of a rectangular area is shifted in units of pixels, and the size of the rectangular area is increased in units of pixels, the entire image can be scanned. Concerning the various features as shown in FIG. 4, the feature generation unit 902 can generate them in the same manner. Information indicating which type of feature is used is beforehand supplied to the feature generation unit 902.

Subsequently, the feature computation unit 903 refers to all images, and determines whether respective feature quantities are computed for all images (step S1003). If the feature quantities are already computed for all images, the program proceeds to step S1005, whereas if they are not yet computed for all images, the program proceeds to step S1004. At step S1004, the feature computation unit 903 computes the feature quantities of all sample images.

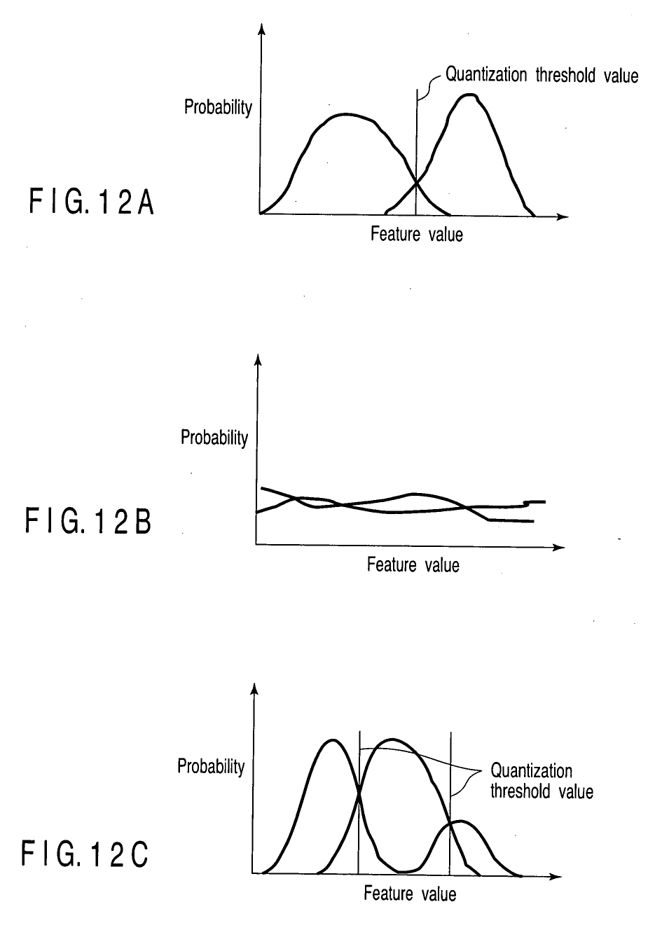

At step S1005, the quantization unit 904 performs quantization. Before quantization, the feature computation unit 903 acquires the respective probability density distributions of feature quantities for the object and the non-object. FIGS. 12A, 12B and 12C show probability density distributions concerning the feature value and acquired from three features. In each of FIGS. 12A, 12B and 12C, two curves indicate the respective probability density distributions for the object and non-object. In the example of FIG. 12A, only small portions of the distributions corresponding to the two classes (object and non-object) overlap each other, which means that the feature corresponding to this figure is effective for classification of the object from the non-object. If, for example, the feature value acquired at which two distributions intersect each other is used as a threshold value, classification can be performed with a small number of classification errors. In contrast, in the example of FIG. 12B, almost the entire curves overlap each other, which means that no threshold value effective to classification exists and hence high classification accuracy cannot be acquired. In the example of FIG. 12C, one distribution has two peaks, which means that a single threshold value cannot provide highly accurate classification. In this case, for example, two threshold values acquired at which the two distributions intersect each other are needed. Threshold-value setting is equivalent to the determination of the quantization method for feature quantities. At step S1005, the quantization unit 904 determines an optimal threshold value for classification of the two classes (object and non-object), and performs quantization. To acquire a threshold value, various methods can be used. For instance, the threshold value can be determined by a well-known method, in which the ratio of the inter-class variance between the two classes to the intra-class variance is used as a criterion and maximized (see “Automatic Threshold-value Selecting Method Based on Classification and Minimum Square Basis” in Article Vol. J63-D, No. 4, pp. 349-356, 1980 published by Institute of Electronics and Communication Engineers of Japan). Instead of the criterion, a threshold value for minimizing a classification error rate concerning sample images for learning may be acquired. Alternatively, the cost of slipping over objects and the cost of erroneously detecting non-objects as objects may be computed beforehand, and a threshold value for minimizing the classification error rate (loss) computed in light of the costs may be acquired. Furthermore, there is a method for determining how many stages quantization should have (i.e., for determining how many threshold values should be used). To this end, a method using a basis called MDL can be utilized (see “Mathematics for Information and Coding” by Han Tae Sun, pp. 323-324). As a result of quantization using the thus-acquired at least one threshold value, the feature value is expressed by a code of 0 when it is smaller than the threshold value, and by a code of 1 when it is larger than it. In quantization of three stages, three codes, such as 0, 1 and 2, may be used.

After computing the feature quantities of all sample images concerning all features, and performing quantization on them, the program proceeds to step S1006. At step S1006, it is determined whether the combination search unit 905 has searched for all combinations of features. If all combinations of features are not yet searched for, the program proceeds to step S1007, whereas if all combinations of features are already searched for, the program proceeds to step S1009. At step S1007, the combination search unit 905 generates another combination of features. The combination search unit 905 generates such combinations of features as shown in FIG. 5. For instance, if two features indicated by the sample 502 are arranged in a certain learning sample, two quantized feature quantities v₁ and v₂ are acquired. Assume here quantization of two stages is performed on both the two features. The combinations of v₁ and v₂ are (0, 0), (0, 1), (1, 0) and (1, 1). v₁ and v₂ are acquired concerning all samples, and it is determined which one of the four patterns is identical to each combination of v₁ and v₂. From this, it can be detected which one of the four patterns will occur with the highest probability. Assuming that P(v₁, v₂|object) is the probability with which a combination of (v₁, v₂) is acquired from an object image sample, the table computation unit 906 computes the probability using the following equation:

$$P \text{(} {v}_{1} , {v}_{2} \vert object ) = \frac{1}{a} {\sum }_{i = 1}^{a} δ ( {v}_{1} - {v}_{1}^{( i )} ) \cdot δ ( {v}_{2} - {v}_{2}^{( i )} )$$

where a is the number of object sample images, and v₁⁽ⁱ⁾ is a value acquired from the i^{th} sample image for the first feature. Further, v₂⁽ⁱ⁾ is a value acquired from the i^{th} sample image for the second feature, and δ(y) is a function that assumes a value of 1 when y=0. Similarly, the table computation unit 906 computes P(v₁, v₂|non-object) from a non-object image sample, using the following equation:

$$P \text{(} {v}_{1} , {v}_{2} \vert non \text{-} object ) = \frac{1}{b} {\sum }_{i = 1}^{b} δ ( {v}_{1} - {v}_{1}^{( i )} ) \cdot δ ( {v}_{2} - {v}_{2}^{( i )} )$$

where b is the number of non-object sample images. Assuming that, more in general, F combinations of features are used, the table computation unit 906 can compute the probabilities P(v₁, . . . , v_{F}|object) and P(v₁, . . . , v_{F}|non-object) using the following equations 9 and 10 that correspond to equations 7 and 8, respectively:

$$P \text{(} {v}_{1} , … , {v}_{F} \vert object ) = \frac{1}{a} {\sum }_{i = 1}^{ a} {\prod }_{f = 1}^{F} δ ( {v}_{f} - {v}_{f}^{( i )} )$$

$$P \text{(} {v}_{1} , … , {v}_{F} \vert non \text{-} object ) = \frac{1}{b} {\sum }_{i = 1}^{ b} {\prod }_{f = 1}^{F} δ ( {v}_{f} - {v}_{f}^{( i )} )$$

These are probabilities (likelihood values) with which v₁, . . . , v_{F} are simultaneously observed in the F combinations of features. A number of probabilities (likelihood values) given by equation 5 can be acquired. The table computation unit 906 computes these probabilities and stores them in the form of a probability table (step S1008). The classifier selector 907 checks a classifier using the probability table and equation 4, and makes the classifier to classify all learning samples and to count the number of classification errors. As a result, it can be determined whether each combination of features is appropriate. At step S1009, the classifier selector 907 selects a classifier in which the number of classification errors is minimum (i.e., the error rate is minimum). In other words, the selector 907 selects an optimal combination of features. The storing unit 908 stores a classifier in which the number of classification errors is minimum, thereby finishing the learning process (step S1010). In the above, for selection of a classifier, the minimum error rate is used as a criterion. Alternatively, estimation values, such as Bhattacharyya bound or a Kullback-Leibler divergence, may be utilized.

A description will be given of several combination methods that can be used at step S1007. The first one is a method of generating all possible combinations. If all possible combinations are checked, an optimal classifier (i.e., optimal combination of features) can be selected. However, in the case of checking all possible combinations, the number of combinations becomes enormous, therefore enormous amounts of time are required for learning.

The second one is a method of combining sequential forward selection (SFS) and sequential backward selection (SBS). In this method, firstly, an optimal one is selected from classifiers that use only one feature, then a classifier is generated by adding another feature to the selected feature, and this classifier is selected if it has a lower error rate than the selected classifier.

The third one is a “plus-l-minus-r” method. In this method, l features are added and the error rate is estimated. If the error rate is not reduced, r features are subtracted to re-estimate the error rate. In the second and third methods, the possibility of detecting an optimal classifier is lower than in the first method, but the number of searches can be reduced compared to the first method.

<<Learning Apparatus (Corresponding to a Plurality of Classifiers>>

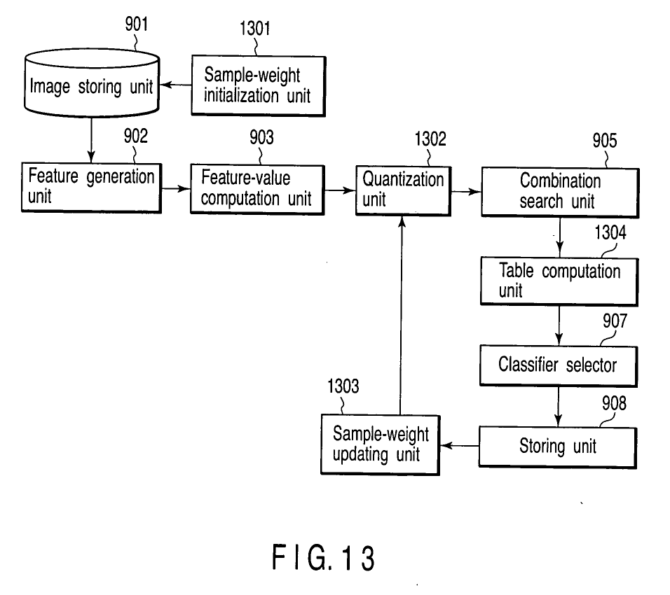

Referring now to FIG. 13, a description will be given of a learning apparatus different from that of FIG. 9. The learning apparatus of FIG. 13 computes parameters used by the classifiers 601, 602, . . . . The classifiers 601, 602, . . . of FIG. 6 can provide more accurate classification results when they are coupled to each other.

The learning apparatus of FIG. 13 comprises a sample-weight initialization unit 1301 and sample-weight updating unit 1303, as well as the elements of the learning apparatus of FIG. 9. Further, a quantization unit 1302 and table computation unit 1304 incorporated in the apparatus of FIG. 13 slightly differ from those of FIG. 9. In FIG. 13, elements similar to those of FIG. 9 are denoted by corresponding reference numerals, and no description will be given thereof.

The sample-weight initialization unit 1301 imparts weights to sample images accumulated in the image storing unit 901. For example, the sample-weight initialization unit 1301 imparts an equal weight as an initial value to all sample images.

The quantization unit 1302 generates a probability density distribution of feature quantities used for computing threshold values for quantization, acquires threshold values based on the probability density distribution, and quantizes each feature value generated by the feature value computation unit 903 into one of discrete values.

The sample-weight updating unit 1303 updates the weight to change the sample image set. Specifically, the sample-weight updating unit 1303 imparts a large weight to a sample image that could not be correctly classified by the classifier, and a small weight to a sample image that could be correctly classified.

The table computation unit 1304 performs computation of a probability table to compute probabilities. The table computation unit 1304 differs form the table computation unit 906 in that the former performs computation based on a weight Dₜ(i), described later, instead of the number of sample images on which the latter performs computation.

The learning apparatus of FIG. 13 utilizes a learning scheme called “Boosting”. Boosting is a scheme for imparting weights to sample images accumulated in the image storing unit 901 and changing the sample set by updating the weights, to acquire a high accuracy classifier.

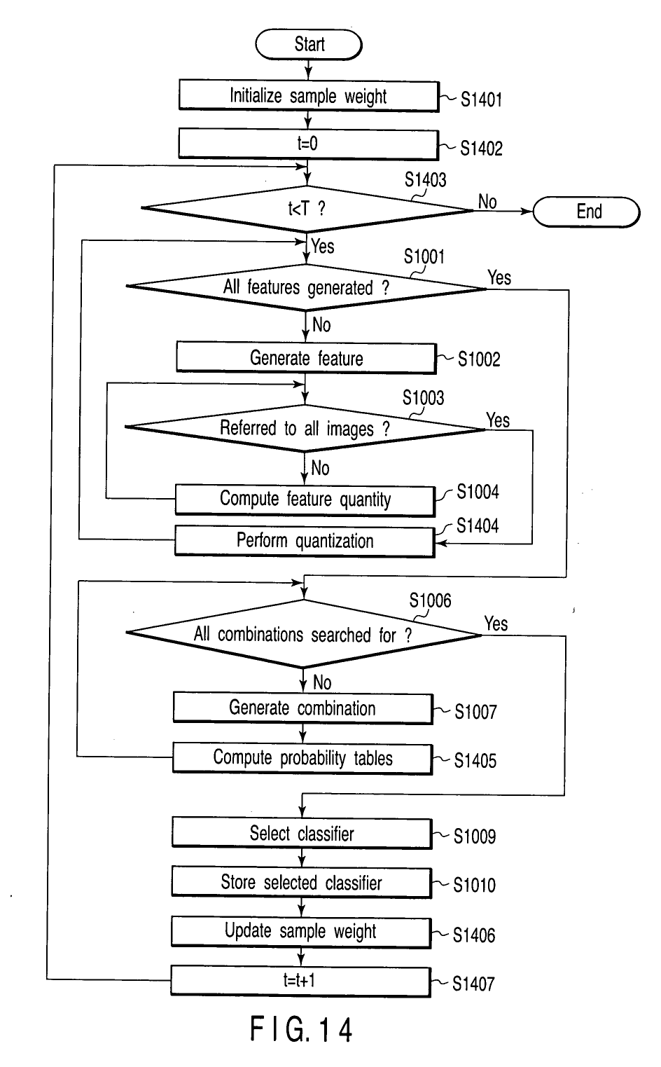

Referring to the flowchart of FIG. 14, the operation of the learning apparatus of FIG. 13 will be described. In FIGS. 10 and 14, like reference numerals denote like steps, and no description will be given thereof. In the learning scheme, the AdaBoost algorithm is utilized. This scheme is similar to that disclosed in Paul Viola and Michael Jones, “Rapid Object Detection using a Boosted Cascade of Simple Features”, IEEE conf. on Computer Vision and Pattern Recognition (CVPR), 2001. However, since the classifiers (601, 602, . . . in FIG. 6) coupled by AdaBoost are higher accuracy ones than in the prior art, the resultant classifier is higher in accuracy than in the prior art.

Firstly, the sample-weight initialization unit 1301 imparts an equal weight to all sample images stored in the image storing unit 901 (step S1401). Assuming that the weight imparted to the i^{th} sample image is D₀(i), it is given by

$${D}_{0} ( i ) = \frac{1}{N}$$

where N is the number of sample images, and N=a+b (the number a of object sample images and the number b of non-object sample images). Subsequently, the feature generation unit 902 sets t to 0 (t=0) (step S1402), and it is determined whether t is smaller than a preset T (step S1403). T corresponds to the number of repetitions of steps S1001 to S1004, step S1404, step S1006, step S1007, step S1405, step S1009, step S1010, step S1406 and step S1407, which are described later. Further, T corresponds to the number of classifiers 601, 602, . . . connected to the uniting section 604 in FIG. 6. If it is determined that t is not smaller than T, the learning apparatus finishes processing, whereas if t is smaller than T, the program proceeds to step S1001.

After that, steps S1001 to S1004 are executed. At step S1401, the quantization unit 1302 generates a probability density distribution of feature quantities for computing a threshold value (threshold values) for quantization. After that, steps S1006 and S1007 are executed. At step S1405, the table computation unit 1304 computes a probability table, i.e., probabilities. At step S1008, probability computation is performed based on the number of samples, whereas at step S1405, it is performed based on the weight Dₜ(i). For instance, the table computation unit 1304 computes the joint probability of simultaneously observing quantized feature quantities, and acquires a value by multiplying the joint probability by the weight Dₜ(i). The classifier selector 907 selects hₜ(xᵢ) the t^{th} classifier (step S1009), the storing unit 908 stores it (step S1010), and the sample-weight updating unit 1303 updates the weight of each sample as indicated by the following equation:

$${D}_{t + 1} ( i ) = \frac{{D}_{t} ( i ) exp ( - {α}_{t} {y}_{i} {h}_{t} ( {x}_{i} ) )}{{Z}_{t}}$$

where xᵢ and yᵢ are the i^{th} sample image and its label (indicating whether the sample image is a detection target), and αₜ is a value given by the following equation using the error rate εₜ of hₜ(x):

$${\ddot{α}}_{t} = \frac{1}{2} ln ( \frac{1 - {ɛ}_{t}}{{ɛ}_{t}} )$$

Using equation 12, the sample-weight updating unit 1303 imparts a large weight to the sample that could not correctly be classified by hₜ(x), and a small weight to the sample that could correctly be classified by hₜ(x). Namely, the next classifier hₜ₊₁(x) exhibits a high classification performance to samples to which the previous classifier exhibits a low classification performance. As a result, a high accuracy classifier as a whole can be acquired. Zₜ in equation 12 is given by

$${Z}_{t} = {\sum }_{i = 1}^{N} {D}_{t} ( i ) exp ( - {α}_{t} {y}_{i} {h}_{t} ( {x}_{i} ) )$$

The classifier finally acquired by the learning apparatus of FIG. 13 performs classification based on equation 6. In general, the threshold value for classification is set to 0, as described above. However, when the error rate of overlooking an object (i.e., the rate of non-detection of an object) is too high, if the threshold value is set to a negative value, the rate of non-detection can be reduced. In contrast, when the error rate of detecting a non-object as an object is too high (this will be referred to as “excessive detection”), if the threshold value is set to a positive value, the detection accuracy can be adjusted.

Instead of AdaBoost, another type of boosting can be employed. For instance, there is a scheme called Real AdaBoost (see R. E. Schapire and Y. Singer, “Improved Boosting Algorithms Using Confidence-rated Predictions”, Machine Learning, 37, pp. 297-336, 1999). In this scheme, the classifier hₜ(x) given by the following equation is used:

$${h}_{t} ( x ) = \frac{1}{2} ln ( \frac{{W}_{object}^{j} + ⅇ}{{W}_{non - object}^{j} + ⅇ} )$$

where W^{j}_{object} and W^{j}_{non-object} are the j^{th} elements of the object-class and non-object-class probability tables, respectively, j indicating the index number of a table corresponding to a feature combination v₁, . . . , v_{F} acquired from an input image x. Further, e is a smoothing term of a small positive number used to deal with the case where W^{j}_{object} and/or W^{j}_{non-object} is 0. In AdaBoost, the classifier hₜ(x) that minimizes the error rate εₜ, while in Real AdaBoost, the classifier that minimizes Zₜ included in the following equation is selected:

$${Z}_{t} = 2 {\sum }_{j} \sqrt{{W}_{object}^{j} {W}_{non - object}^{j}}$$

In this case, the sample-weight updating unit 1303 updates the weight of each sample at step S1405 based on the following equation:

$${D}_{t + 1} ( i ) = \frac{{D}_{t} ( i ) exp ( - {y}_{i} {h}_{t} ( {x}_{i} ) )}{{Z}_{t}}$$

The equation for update does not contain at, which differs from update equation 12 for AdaBoost. This is because in Real AdaBoost, each classifier outputs a continuous value shown in equation 14, instead of a class label. The classifier selector 907 selects the finally acquired classifier, using the following equation:

$$H ( x ) = {\sum }_{t = 1}^{T} {h}_{t} ( x )$$

The classifier selector 907 compares H(x) with a threshold value (usually, 0). If H(x) is larger than the threshold value, it is determined that the sample image is an object, while if H(x) is smaller than the threshold value, the sample image is determined to be a non-object. Concerning non-detection and excessive detection, they can be dealt with by threshold-value adjustment as in AdaBoost.

As described above, in the embodiment, the object detection apparatus can perform, with a higher accuracy than in the prior art, a determination as to whether a detection image contains an object, from feature quantities computed by applying combinations of feature areas to the detection image, based on combinations of feature areas, quantized feature quantities corresponding to the combinations, joint probability, and information as to whether each sample image is an object, which are beforehand acquired by the learning apparatus. In other words, the embodiment provides the same detection accuracy as in the prior art, with a smaller number of computations.

The flow charts of the embodiments illustrate methods and systems according to the embodiments of the invention. It will be understood that each block of the flowchart illustrations, and combinations of blocks in the flowchart illustrations, can be implemented by computer program instructions. These computer program instructions may be loaded onto a computer or other programmable apparatus to produce a machine, such that the instructions which execute on the computer or other programmable apparatus create means for implementing the functions specified in the flowchart block or blocks. These computer program instructions may also be stored in a computer-readable memory that can direct a computer or other programmable apparatus to function in a particular manner, such that the instruction stored in the computer-readable memory produce an article of manufacture including instruction means which implement the function specified in the flowchart block of blocks. The computer program instructions may also be loaded onto a computer or other programmable apparatus to cause a series of operational steps to be performed on the computer or other programmable apparatus to produce a computer programmable apparatus provide steps for implementing the functions specified in the flowchart block or blocks.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An object detection apparatus comprising:
a storing unit configured to store learned information learned previously with respect to a sample image extracted from an input image and including first information and second information, the first information indicating at least one combination of a given number of feature-region/feature-value groups selected from a plurality of feature-region/feature-value groups each including one of feature areas and one of quantized learned-feature quantities, the feature areas each having a plurality of pixel areas, and the quantized learned-feature quantities obtained by quantizing learned-feature quantities corresponding to feature quantities of the feature areas in the sample image, and the second information indicating whether the sample image is an object or a non-object;
a feature-value computation unit configured to compute an input feature value of each of the feature areas belonging to the combination in the input image;
a quantization unit configured to quantize the computed input feature value to obtain quantized input feature value; and
a determination unit configured to determine whether the input image includes the object, using the quantized input feature value and the learned information.

2. The apparatus according to claim 1, wherein:
the first information indicating a plurality of combinations of the given number of feature-region/feature-value groups selected from the plurality of feature-region/feature-value groups;
the feature-value computation unit computes a plurality of input feature quantities with respect to the combinations; and
the determination unit performs a determination using the input feature quantities corresponding to the combinations;
and further comprising:
a total determination unit configured to determine whether the input image includes the object, using a weighted sum of the determination results each acquired by the determination unit from the combinations.

3. The apparatus according to claim 1, wherein the feature-value computation unit computes the input feature value by computing a weighted sum of sum of pixel value in each of the pixel areas included in each of the feature areas, or an absolute value of the weighted sum of the sum of the pixel value.

4. The apparatus according to claim 1, wherein the feature-value computation unit computes a difference value between average brightness values of different pixel areas as a feature value in units of feature areas.

5. The apparatus according to claim 1, wherein the quantization unit quantizes the computed input feature value into one of two discrete values.

6. A learning apparatus comprising:
a first storing unit configured to store at least two sample images, one of the sample images being an object as a detection target and the other sample image being a non-object as a non-detection target;
a feature generation unit configured to generate a plurality of feature areas each of which includes a plurality of pixel areas, the feature areas being not more than a maximum number of feature areas which are arranged in each of the sample images;
a feature computation unit configured to compute, for each of the sample images, a feature value of each of the feature areas;
a probability computation unit configured to compute a probability of occurrence of the feature value corresponding to each of the feature areas, depending upon whether each of the sample images is the object, and then to quantize the feature value into one of a plurality of discrete values based on the computed probability;
a combination generation unit configured to generate a plurality of combinations of the feature areas;
a joint probability computation unit configured to compute, in accordance with each of the combinations, a joint probability with which the quantized feature quantities are simultaneously observed in each of the sample images, and generate tables storing the generated combinations, the computed joint probabilities, and information indicating whether each of the sample images is the object or the non-object;
a determination unit configured to determine, concerning each of the combinations with reference to the tables, whether a ratio of a joint probability indicating the object sample image to a joint probability indicating the non-object sample image is higher than a threshold value, to determine whether each of the sample images is the object;
a selector configured to select, from the combinations, a combination which minimizes number of errors in determination results corresponding to the sample images; and
a second storing unit which stores the selected combination and one of the tables corresponding to the selected combination.

7. The apparatus according to claim 6, wherein the feature computation unit computes the feature value by computing a weighted sum of sum of pixel value in each of the pixel areas included in each of the feature areas, or an absolute value of the weighted sum.

8. The apparatus according to claim 6, wherein the feature computation unit computes the feature value of each of the feature areas by computing a difference value between average brightness values of different pixel areas.

9. The apparatus according to claim 6, wherein the probability computation unit quantizes the feature value into one of two discrete values.

10. A learning apparatus comprising:
a first storing unit which stores at least two sample images, one of the sample images being an object as a detection target and the other sample image being a non-object as a non-detection target;
an imparting unit configured to impart an initial weight to the stored sample images;
a feature generation unit configured to generate a plurality of feature areas each of which includes a plurality of pixel areas, the feature areas being not more than a maximum number of feature areas which are arranged in each of the sample images;
a feature computation unit configured to compute, for each of the sample images, a weighted sum of differently weighted pixel areas included in each of the feature areas, or an absolute value of the weighted sum, the weighted sum or the absolute value being used as a feature value corresponding to each of the feature areas;
a probability computation unit configured to compute a probability of occurrence of the feature value corresponding to each of the feature areas, depending upon whether each of the sample images is the object, and then to quantize the feature value into one of a plurality of discrete values based on the computed probability;
a combination generation unit configured to generate a plurality of combinations of the feature areas;
a joint probability computation unit configured to compute, in accordance with each of the combinations, a joint probability with which the quantized feature quantities are simultaneously observed in each of the sample images, and generate tables storing the generated combinations, the quantized feature quantities, a plurality of values acquired by multiplying the computed joint probabilities by the initial weight, and information indicating whether each of the sample images is the object or the non-object;
a determination unit configured to determine, concerning each of the combinations with reference to the tables, whether a ratio of a value acquired by multiplying a joint probability indicating the object sample image by the initial weight to a value acquired by multiplying a joint probability indicating the non-object sample image by the initial weight is higher than a threshold value, to determine whether each of the sample images is the object;
a selector configured to select, from the combinations, a combination which minimizes number of errors in determination results corresponding to the sample images;
a second storing unit which stores the selected combination and one of the tables corresponding to the selected combination; and
an update unit configured to update a weight of any one of the sample images to increase the weight when the sample images are subjected to a determination based on the selected combination, and a determination result concerning the any one of the sample images indicating an error,
wherein:
the joint probability computation unit generates tables storing the generated combinations, a plurality of values acquired by multiplying the computed joint probabilities by the updated weight, and information indicating whether each of the sample images is the object or the non-object;
the determination unit performs a determination based on the values acquired by multiplying the computed joint probabilities by the updated weight;
the selector selects, from a plurality of combinations determined based on the updated weight, a combination which minimizes number of errors in determination results corresponding to the sample images; and
the second storing unit newly stores the combination selected by the selector, and one of the tables corresponding to the combination selected by the selector.

11. The apparatus according to claim 10, wherein the second storing unit newly stores the combination selected by the selector, and one of the tables corresponding to the combination selected by the selector, when a probability with which determination results acquired using the combination selected by the selector are determined erroneous is lower than a probability with which determination results acquired using the combinations previously stored in the second storing unit.

12. The apparatus according to claim 10, wherein the feature computation unit computes the feature value of each of the feature areas by computing a difference value between average brightness values of different pixel areas.

13. The apparatus according to claim 10, wherein the probability computation unit quantizes the feature value into one of two discrete values.

14. An object detection system comprising a learning apparatus and an object detection apparatus,
the learning apparatus including:
a first storing unit configured to store at least two sample images, one of the sample images being an object as a detection target and the other sample image being a non-object as a non-detection target;
a feature generation unit configured to generate a plurality of feature areas each of which includes a plurality of pixel areas, the feature areas being not more than a maximum number of feature areas which are arranged in each of the sample images;
a feature computation unit configured to compute, for each of the sample images, a feature value of each of the feature areas;
a probability computation unit configured to compute a probability of occurrence of the feature value corresponding to each of the feature areas, depending upon whether each of the sample images is the object, and then to quantize the feature value into one of a plurality of discrete values based on the computed probability;
a combination generation unit configured to generate a plurality of combinations of the feature areas;
a joint probability computation unit configured to compute, in accordance with each of the combinations, a joint probability with which the quantized feature quantities are simultaneously observed in each of the sample images, and generate tables storing the generated combinations, the computed joint probabilities, and information indicating whether each of the sample images is the object or the non-object;
a first determination unit configured to determine, concerning each of the combinations with reference to the tables, whether a ratio of a joint probability indicating the object sample image to a joint probability indicating the non-object sample image is higher than a threshold value, to determine whether each of the sample images is the object;
a selector configured to select, from the combinations, a combination which minimizes number of errors in determination results corresponding to the sample images; and
a second storing unit which stores the selected combination and one of the tables corresponding to the selected combination, and
the object detection apparatus including:
a feature-value computation unit configured to compute an input feature value of each of the feature areas belonging to the combination in an input image;
a quantization unit configured to quantize the computed input feature value to obtain quantized input feature value; and
a second determination unit configured to determine whether the input image includes the object, using the quantized input feature value and the one of the tables stored in the second storing unit.

15. An object detection system comprising a learning apparatus and an object detection apparatus,
the learning apparatus including:
a first storing unit which stores at least two sample images, one of the sample images being an object as a detection target and the other sample image being a non-object as a non-detection target;
an imparting unit configured to impart an initial weight to the stored sample images;
a feature generation unit configured to generate a plurality of feature areas each of which includes a plurality of pixel areas, the feature areas being not more than a maximum number of feature areas which are arranged in each of the sample images;
a first computation unit configured to compute, for each of the sample images, a weighted sum of differently weighted pixel areas included in each of the feature areas, or an absolute value of the weighted sum, the weighted sum or the absolute value being used as a feature value corresponding to each of the feature areas;
a probability computation unit configured to compute a probability of occurrence of the feature value corresponding to each of the feature areas, depending upon whether each of the sample images is the object, and then to quantize the feature value into one of a plurality of discrete values based on the computed probability;
a combination generation unit configured to generate a plurality of combinations of the feature areas;
a joint probability computation unit configured to compute, in accordance with each of the combinations, a joint probability with which the quantized feature quantities are simultaneously observed in each of the sample images, and generate tables storing the generated combinations, the quantized feature quantities, a plurality of values acquired by multiplying the computed joint probabilities by the initial weight, and information indicating whether each of the sample images is the object or the non-object;
a first determination unit configured to determine, concerning each of the combinations with reference to the tables, whether a ratio of a value acquired by multiplying a joint probability indicating the object sample image by the initial weight to a value acquired by multiplying a joint probability indicating the non-object sample image by the initial weight is higher than a threshold value, to determine whether each of the sample images is the object;
a selector configured to select, from the combinations, a combination which minimizes number of errors in determination results corresponding to the sample images;
a second storing unit which stores the selected combination and one of the tables corresponding to the selected combination; and
an update unit configured to update a weight of any one of the sample images to increase the weight when the sample images are subjected to a determination based on the selected combination, and a determination result concerning the any one of the sample images indicates an error,
wherein:
the joint probability computation unit generates tables storing the generated combinations, a plurality of values acquired by multiplying the computed joint probabilities by the updated weight, and information indicating whether each of the sample images is the object or the non-object;
the first determination unit performs a determination based on the values acquired by multiplying the computed joint probabilities by the updated weight;
the selector selects, from a plurality of combinations determined based on the updated weight, a combination which minimizes number of errors in determination results corresponding to the sample images; and
the second storing unit newly stores the combination selected by the selector, and one of the tables corresponding to the combination selected by the selector,
the object detection apparatus including:
a second computation unit configured to compute an input feature value of each of the feature areas belonging to the combination in an input image;
a quantization unit configured to quantize the computed input feature value into one of the discrete values in accordance with the input feature value to obtain quantized input feature value;
a second determination unit configured to determine whether the input image includes the object, referring to the selected combination and the one of the tables; and
a total determination unit configured to determine whether the input image includes the object, using a weighted sum acquired by imparting weights to a plurality of determination results acquired by the second determination unit concerning the plurality of combinations.

16. An object detection method comprising:
storing learned information learned previously with respect to a sample image extracted from an input image and including first information and second information, the first information indicating at least one combination of a given number of feature-region/feature-value groups selected from a plurality of feature-region/feature-value groups each including one of feature areas and one of quantized learned-feature quantities, the feature areas each having a plurality of pixel areas, and the quantized learned-feature quantities obtained by quantizing learned-feature quantities corresponding to feature quantities of the feature areas in the sample image, and the second information indicating whether the sample images is an object or a non-object;
computing an input feature value of each of the feature areas belonging to the combination in the input image;
quantizing the computed input feature value to obtain quantized input feature value; and
determining whether the input image includes the object, using the quantized input feature value and the learned information.

17. The method according to claim 16, wherein:
the first information indicating a plurality of combinations of the given number of feature-region/feature-value groups selected from the plurality of feature-region/feature-value groups;
computing the input feature value includes computing a plurality of input feature quantities with respect to the combinations; and
the determining includes performing a determination using the input feature quantities corresponding to the combinations,
and further comprising:
determining whether the input image includes the object, using a weighted sum of the determination results each acquired by the determining from the combinations.

18. A learning method comprising:
storing at least two sample images, one of the sample images being an object as a detection target and the other sample image being a non-object as a non-detection target;
generating a plurality of feature areas each of which includes a plurality of pixel areas, the feature areas being not more than a maximum number of feature areas which are arranged in-each of the sample images;
computing, for each of the sample images, a feature value of each of the feature areas;
computing a probability of occurrence of the feature value corresponding to each of the feature areas, depending upon whether each of the sample images is the object, and then quantizing the feature value into one of a plurality of discrete values based on the computed probability;
generating a plurality of combinations of the feature areas;
computing, in accordance with each of the combinations, a joint probability with which the quantized feature quantities are simultaneously observed in each of the sample images, and generating tables storing the generated combinations, the computed joint probabilities, and information indicating whether each of the sample images is the object or the non-object;
determining, concerning each of the combinations with reference to the tables, whether a ratio of a joint probability indicating the object sample image to a joint probability indicating the non-object sample image is higher than a threshold value, to determine whether each of the sample images is the object;
selecting, from the combinations, a combination which minimizes number of errors in determination results corresponding to the sample images; and
storing the selected combination and one of the tables corresponding to the selected combination.

19. A learning method comprising:
storing at least two sample images, one of the sample images being an object as a detection target and the other sample image being a non-object as a non-detection target;
imparting an initial weight to the stored sample images;
generating a plurality of feature areas, each of which includes a plurality of pixel areas, the feature areas being not more than a maximum number of feature areas which are arranged in each of the sample images;
computing, for each of the sample images, a weighted sum of differently weighted pixel areas included in each of the feature areas, or an absolute value of the weighted sum, the weighted sum or the absolute value being used as a feature value corresponding to each of the feature areas;
computing a probability of occurrence of the feature value corresponding to each of the feature areas, depending upon whether each of the sample images is the object, and then quantizing the feature value into one of a plurality of discrete values based on the computed probability;
generating a plurality of combinations of the feature areas;
computing, in accordance with each of the combinations, a joint probability with which the quantized feature quantities are simultaneously observed in each of the sample images, and generating tables storing the generated combinations, the quantized feature quantities, a plurality of values acquired by multiplying the computed joint probabilities by the initial weight, and information indicating whether each of the sample images is the object or the non-object;
determining, concerning each of the combinations with reference to the tables, whether a ratio of a value acquired by multiplying a joint probability indicating the object sample image by the initial weight to a value acquired by multiplying a joint probability indicating the non-object sample image by the initial weight is higher than a threshold value, to determine whether each of the sample images is the object;
selecting, from the combinations, a combination which minimizes number of errors in determination results corresponding to the sample images;
storing the selected combination and one of the tables corresponding to the selected combination;
updating a weight of any one of the sample images to increase the weight when the sample images are subjected to a determination based on the selected combination, and a determination result concerning the any one of the sample images indicating an error;
generating tables storing the generated combinations, a plurality of values acquired by multiplying the computed joint probabilities by the updated weight, and information indicating whether each of the sample images is the object or the non-object;
performing a determination based on the values acquired by multiplying the computed joint probabilities by the updated weight;
selecting, from a plurality of combinations determined based on the updated weight, a combination which minimizes number of errors in determination results corresponding to the sample images; and
newly storing the selected combination and one of the tables corresponding to the selected combination.

20. An object detection program stored in a computer-readable medium using a computer, the program comprising:
means for instructing the computer to store learned information learned previously with respect to a sample image extracted from an input image and including first information and second information, the first information indicating at least one combination of a given number of feature-region/feature-value groups selected from a plurality of feature-region/feature-value groups each including one of feature areas and one of quantized learned-feature quantities, the feature areas each having a plurality of pixel areas, and the quantized learned-feature quantities obtained by quantizing learned-feature quantities corresponding to feature quantities of the feature areas in the sample image, and the second information indicating whether the sample images is an object or a non-object;
computation means for instructing the computer to compute an input feature value of each of the feature areas belonging to the combination in the input image;
means for instructing the computer to quantize the computed input feature value to obtain quantized input feature value; and
determination means for instructing the computer to determine whether the input image includes the object, using the quantized input feature value and the learned information stored.

21. The program according to claim 20, wherein:
the first information indicating a plurality of combinations of the given number of feature-region/feature-value groups selected from the plurality of feature-region/feature-value groups;
the computation means instructs the computer to compute a plurality of input feature quantities with respect to the combinations; and
the determination means instructs the computer to perform a determination using the input feature quantities corresponding to the combinations;
and further comprising:
means for instructing the computer to determine whether the input image includes the object, using a weighted sum of the determination results each acquired from the combinations.

22. A learning program stored in a computer-readable medium, the program comprising:
means for instructing a computer to store at least two sample images, one of the sample images being an object as a detection target and the other sample image being a non-object as a non-detection target;
means for instructing the computer to generate a plurality of feature areas each of which includes a plurality of pixel areas, the feature areas being not more than a maximum number of feature areas which are arranged in each of the sample images;
means for instructing the computer to compute, for each of the sample images, a feature value of each of the feature areas;
means for instructing the computer to compute a probability of occurrence of the feature value corresponding to each of the feature areas, depending upon whether each of the sample images is the object, and then to quantize the feature value into one of a plurality of discrete values based on the computed probability;
means for instructing the computer to generate a plurality of combinations of the feature areas;
means for instructing the computer to compute, in accordance with each of the combinations, a joint probability with which the quantized feature quantities are simultaneously observed in each of the sample images, and generate tables storing the generated combinations, the computed joint probabilities, and information indicating whether each of the sample images is the object or the non-object;
means for instructing the computer to determine, concerning each of the combinations with reference to the tables, whether a ratio of a joint probability indicating the object sample image to a joint probability indicating the non-object sample image is higher than a threshold value, to determine whether each of the sample images is the object;
means for instructing the computer to select, from the combinations, a combination which minimizes number of errors in determination results corresponding to the sample images; and
means for instructing the computer to store the selected combination and one of the tables corresponding to the selected combination.

23. A learning program stored in a computer-readable medium, the program comprising:
means for instructing a computer to store at least two sample images, one of the sample images being an object as a detection target and the other sample image being a non-object as a non-detection target;
means for instructing the computer to impart an initial weight to the stored sample images;
means for instructing the computer to generate a plurality of feature areas each of which includes a plurality of pixel areas, the feature areas being not more than a maximum number of feature areas which are arranged in each of the sample images;
means for instructing the computer to compute, for each of the sample images, a weighted sum of differently weighted pixel areas included in each of the feature areas, or an absolute value of the weighted sum, the weighted sum or the absolute value being used as a feature value corresponding to each of the feature areas;
means for instructing the computer to compute a probability of occurrence of the feature value corresponding to each of the feature areas, depending upon whether each of the sample images is the object, and then to quantize the feature value into one of a plurality of discrete values based on the computed probability;
means for instructing the computer to generate a plurality of combinations of the feature areas;
acquisition means for instructing the computer to compute, in accordance with each of the combinations, a joint probability with which the quantized feature quantities are simultaneously observed in each of the sample images, and generate tables storing the generated combinations, the quantized feature quantities, a plurality of values acquired by multiplying the computed joint probabilities by the initial weight, and information indicating whether each of the sample images is the object or the non-object;
determination means for instructing the computer to determine, concerning each of the combinations with reference to the tables, whether a ratio of a value obtained by multiplying a joint probability indicating the object sample image by the initial weight to a value obtained by multiplying a joint probability indicating the non-object sample image by the initial weight is higher than a threshold value, to determine whether each of the sample images is the object;
selection means for instructing the computer to select, from the combinations, a combination which minimizes number of errors in determination results corresponding to the sample images;
storing means for instructing the computer to store the selected combination and one of the tables corresponding to the selected combination; and
means for instructing the computer to update a weight of any one of the sample images to increase the weight when the sample images are subjected to a determination based on the selected combination, and a determination result concerning the any one of the sample images indicating an error,
wherein:
the acquisition means instructs the computer to generate tables storing the generated combinations, a plurality of values obtained by multiplying the computed joint probabilities by the updated weight, and information indicating whether each of the sample images is the object or the non-object;
the determination means instructs the computer to perform a determination based on the values obtained by multiplying the computed joint probabilities by the updated weight;
the selection means instructs the computer to select, from a plurality of combinations determined based on the updated weight, a combination which minimizes number of errors in determination results corresponding to the sample images; and
the storing means instructs the computer to newly store the selected combination, and one of the tables corresponding to the selected combination.
